(19) United States
(12) Patent Application Publication
(10) Pub. No.: US 2008/0226308 A1
(43) Pub. Date: Sep. 18, 2008

(54) Web cartridge refurbishment verification

(76) Inventors: Tanya V. Burmeister, Vancouver, WA (US); Russell P. Yearout, Vancouver, WA (US); Antonio Gomez, Vancouver, WA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/717,260

(22) Filed: Mar. 13, 2007

(51) Int. Cl. G03G 15/00

(52) U.S. Cl. 399/12

(57) ABSTRACT

A method of verifying web cartridge refurbishment is disclosed. The method includes installing a refurbished web cartridge in a print apparatus, the print apparatus comprising an encoder and a web sensor and utilizing the encoder and the web sensor to verify refurbishment of the installed web cartridge.

### BACKGROUND

One major challenge that comes with cleaning large, long life print heads with a web fabric is that it is not feasible to store a lifetime of material in the product. Consequently, the print head cleaning system must be serviced at the customer site with replacement material several times. Typically, the used cleaning components are either discarded or shipped to a remote location for a factory refurbishment. If the components are discarded, the components must be replaced. If the components are shipped to a remote location for a factory refurbishment, considerable costs are incurred as a result of shipping and labor.

An alternate method of refurbishing the components involves removing the used components on site and replacing them directly. However, once the components are replaced, there is no way to verify that the components have been properly refurbished. The present invention addresses this need.

### BRIEF DESCRIPTION OF THE DRAWINGS

FIG. 1 is a schematic illustration of a printing system according to one exemplary embodiment.

FIG. 2 is a sectional view of the printing system in accordance with an embodiment.

FIG. 3 is a perspective view of the web cartridge in accordance with an embodiment.

FIG. 4 is another perspective view of the web cartridge in accordance with an embodiment.

FIG. 5 is flowchart of a method in accordance with an embodiment.

FIG. 6 shows a more detailed illustration of the refurbishment verification module in accordance with an embodiment.

FIG. 7 is another perspective view of the web cartridge in accordance with an embodiment.

### DETAILED DESCRIPTION

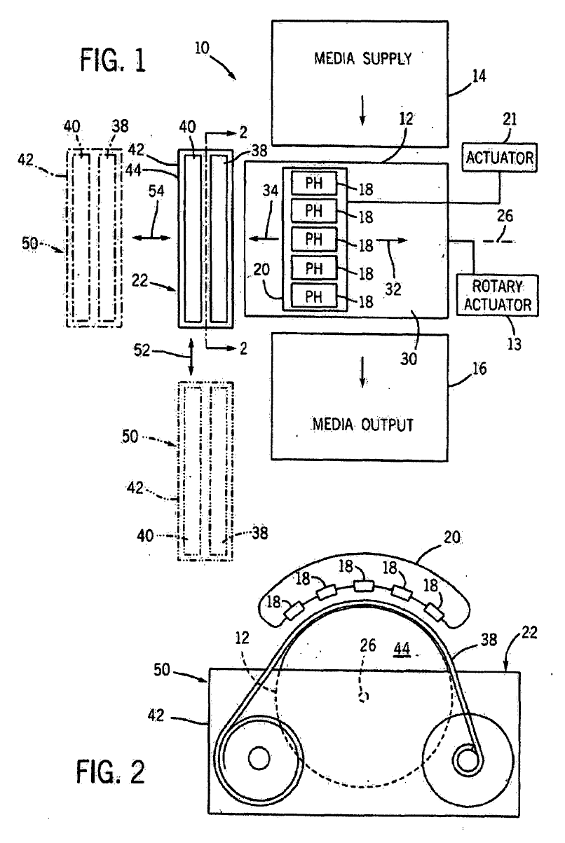

FIGS. 1 and 2 schematically illustrate a printing system 10 according to one exemplary embodiment. Printing system 10 generally includes drum 12, rotary actuator 13, media supply 14, media output 16, printheads 18, carriage 20, actuator 21 and service station 22. Drum 12 generally includes an elongated cylinder configured to be rotatably driven about axis 26 by rotary actuator 13 while transporting media, such as paper, about axis 26 relative to printheads 18. Rotary actuator 13 includes a source of torque, such as a motor, operably coupled to drum 12 by a transmission (not shown).

Media supply 14, schematically shown, includes a mechanism configured to supply media to drum 12. In one embodiment, media supply 14 includes a mechanism configured to pick an individual sheet of media from a stack of media and to supply the individual sheet to drum 12 such that the sheet is wrapped at least partially about drum 12. Media output 16, schematically shown, includes a mechanism to withdraw printed upon media from drum 12 and to transport withdrawn media to and contain withdrawn media within an output tray, bin or the like.

Printheads 18 include printheads configured to dispense imaging material, such as ink, upon the medium held by drum 12. In one embodiment, printheads 18 include piezo electric printheads. In another embodiment, printheads 18 include thermal inkjet printheads. As shown by FIG. 2, printheads 18 are arranged in an arc about axis 26. As a result, printheads 18 are configured to print across a larger area of the media supported by drum 12. In the particular embodiment, drum 12 has an outer surface 30 also arranged in an arc about axis 26. Printheads 18 are arranged in an arc substantially identical to the arc in which surface 30 extends.

Carriage 20 includes one or more structures configured to support printheads 18 in the arcuate arrangement. In addition, carriage 20 is configured to movably support printheads 18 along axis 26. Actuator 21 includes a linear actuator configured to move carriage 20 and printheads 18 in the directions indicated by arrows 32, 34 so as to selectively position printheads 18 opposite to the media held by drum 12 or opposite to service station 22. In one embodiment, actuator 21 may include a motor configured to drive a toothed pulley in engagement with a toothed belt coupled to carriage 20.

In another embodiment, actuator 21 may include other forms of a linear actuator using rack and pinion arrangements, hydraulic, pneumatic or electrical means. Although system 10 is illustrated as including five printheads supported by a single carriage 20, system 10 may alternatively include a greater or fewer number of such printheads 18 supported by one or more carriages 20.

Service station 22 includes a station located on an axial end of drum 12 such that carriage 20 may position printheads 18 opposite, or adjacent, to station 22. Station 22 includes one or more components configured to perform servicing operations upon one or more of the printheads 18. As shown by FIG. 1, service station 22 includes two webs 38, 40 of material for performing servicing operations upon printheads 18. In one embodiment, web 38 is configured to interact with printheads 18 by receiving printing material or ink discharged from printheads 18. For example, in one embodiment, printheads 18 include multiple nozzles. Web 38 facilitates spitting of ink from the nozzles to clear such nozzles. The web 38 is thus referred to as the spit web. In one embodiment, the spit web 38 includes a web of fluid absorbent material such as fabric material or the like.

Web 40 includes an elongate band of material configured to perform a distinct servicing operation upon printheads 18. In the embodiment illustrated, web 40 includes a web of material configured to physically contact the surfaces of printheads 18 so as to wipe printheads 18. The web 40 is thus referred to as the wipe web. In the particular example illustrated, the wipe web 40 is configured to contact the surfaces of printheads 18 as the carriage 20 moves the printheads 18 along axis 26 relative to the wipe web 40 to wipe the printheads 18. In other embodiments, the wipe web 40 may additionally be configured to be moved relative to the printheads 18 to perform such wiping operations. According to one embodiment, web 40 is formed from a fabric material such as Evolon 100 commercially available from the Freudenberg Group of Germany.

As shown by FIG. 2, in the particular example shown, service station 22 further includes a housing 42 and a track 44. Housing 42 includes one or more walls, panels, structures and the like configured to support track 44 and webs 38, 40 relative to drum 12. As shown by FIG. 1, housing 42 supports track 44 and webs 38, 40 as a single individual unit or cartridge 50 that is configured to be removed from drum 12. In one embodiment, cartridge 50 is configured to be inserted adjacent to or removed from drum 12 by movement substantially perpendicular to axis 26 as indicated by arrows 52. In another embodiment, cartridge 50 is configured to be inserted adjacent to or removed from drum 12 in a direction substantially parallel to axis 26 as indicated by arrow 54.

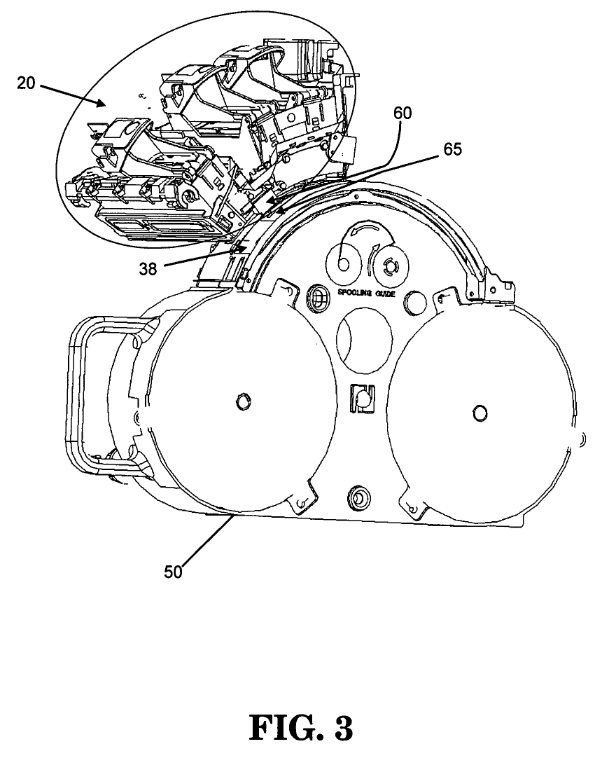

Turning to FIG. 3, an embodiment of the web cartridge 50 is shown in more detail. FIG. 3 shows the carriage 20 in conjunction with the web cartridge 50. Also shown is a sensor 60. Sensor 60 is coupled to the carriage 20 so as to sense and detect the remaining windings of material contained within cartridge 50. In the particular example shown, sensor 60 is configured to cooperate with a viewing area 65 to detect expended and remaining amounts of the spit web 38 that have been used by service station 22. In the particular example shown, sensor 60 is an optical sensor which determines the amount of windings left based upon reflected light. However, one of ordinary skill in the art will readily recognize that the sensor 60 could be a variety of other types of sensors.

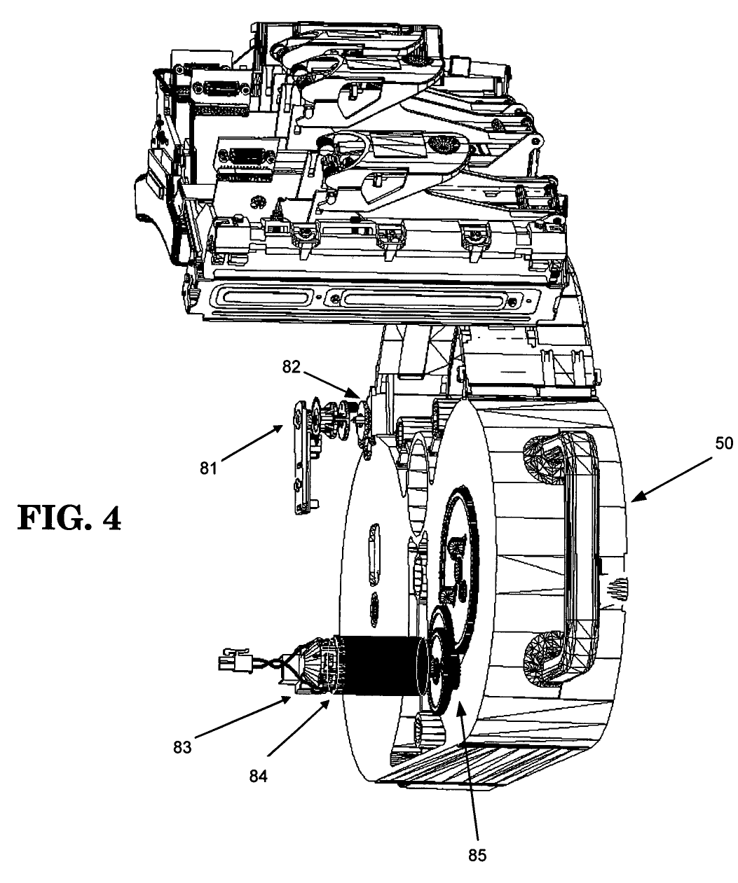

FIG. 4 is another perspective view of the web cartridge in accordance with an embodiment. FIG. 4 shows a wipe web encoder 81, a web drive encoder 82 and a web drive motor 83. The wipe web encoder 81 tracks the linear distance of the motion of the fabric dispensed by the wipe web 40. This is accomplished by reading an encoded disk 82 attached to the end of a shaft that rotates as the wipe web material is dispensed. The web drive motor 84 is an electric motor with an internal encoder 83. The primary function of the web drive motor 84 is to drive a transmission 85 coupled to the web cartridge 50, the transmission 85 configured to appropriately adjust the speed and torque provided by the web drive motor 84 to the web cartridge 50.

The removability of cartridge 50 facilitates replacement, repair, refurbishment, or refilling of cartridge 50. For example, when one or both of webs 38, 40 becomes sufficiently saturated with printing material or ink from printheads 18, cartridge 50 may be removed and either replaced with an entirely new cartridge or be refilled with another one of webs 38 and/or 40. Alternatively, if cartridge 50 has become damaged, cartridge 50 may be replaced. As a result, the useful life of printing system 10 is not limited by the useful life of web 38 or web 40. However, a method of verifying this refurbishment should be employed.

Accordingly, an embodiment of the present invention includes a method of verifying web cartridge refurbishment. The method includes installing a refurbished web cartridge in a print apparatus, the print apparatus comprising an encoder and a web sensor and utilizing the encoder and the web sensor to verify refurbishment of the installed web cartridge. By implementing this method, a quick and reliable refurbishment of the web cartridge is completed in a more cost effective and efficient manner.

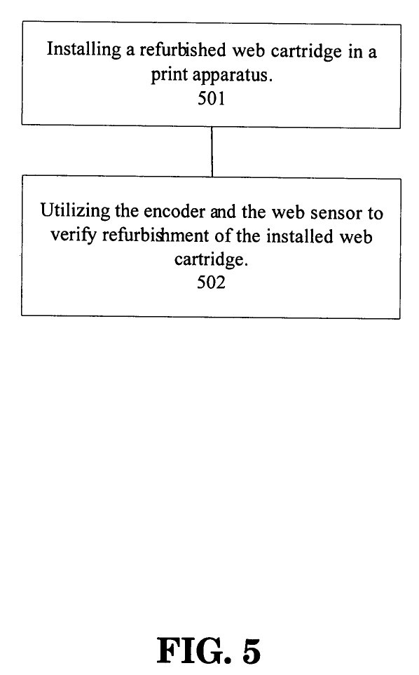

FIG. 5 is a flowchart of a method in accordance with an embodiment. A first step 501 involves installing a refurbished web cartridge in a print apparatus, the print apparatus including an encoder and a web sensor. A second step 502 includes utilizing the encoder and the web sensor to verify refurbishment of the installed web cartridge.

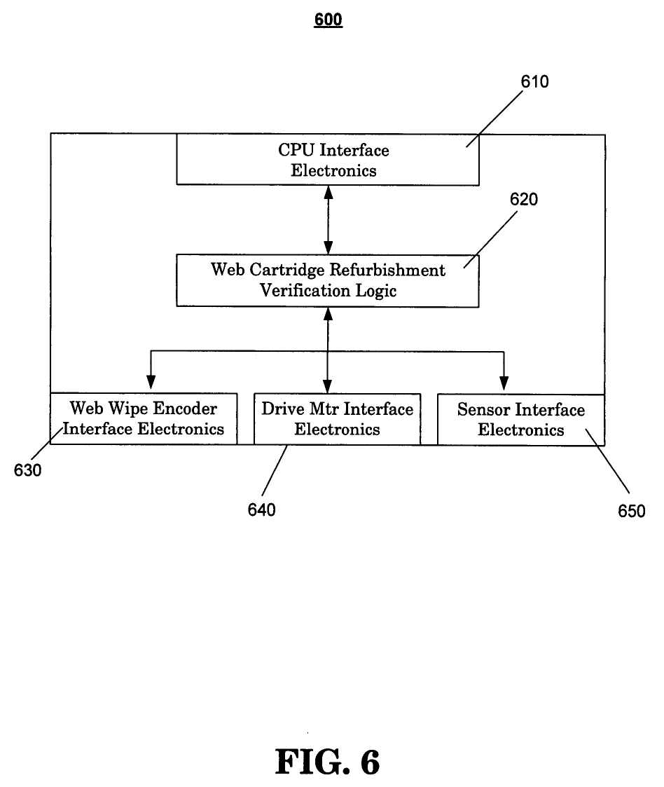

In order to accomplish the above-referenced steps, a refurbishment verification module could be employed to interact with the printing system's central processing unit (CPU). Referring now to FIG. 6, an exemplary refurbishment verification module 600 is illustrated. The refurbishment verification module 600 is configured to monitor the sensor 60, the wipe web encoder 81 and the web drive motor 84. The refurbishment verification module 600 includes central processing unit (CPU) interface electronics 610, web cartridge refurbishment verification logic 620, wipe web encoder interface electronics 630, drive motor interface logic 640 and sensor interface electronics 650. The CPU interface electronics 610 are coupled to the web cartridge refurbishment verification logic 620 wherein the web cartridge refurbishment verification logic 620 is further coupled to the wipe web encoder interface electronics 630, drive motor interface logic 640 and sensor interface electronics 650.

Although the components of the above-described refurbishment verification module 600 are shown in a specific configuration, one of ordinary skill in the art will readily recognize the components of the refurbishment verification module 600 could be configured in a variety of ways.

The CPU interface electronics 610, the wipe web encoder interface electronics 620, the drive motor interface logic 640 and the sensor interface electronics 650 include the electronic circuitry employed by the refurbishment verification module 600 to respectively communicate with the CPU (not shown), wipe web encoder 81, the drive motor 84 and the sensor 60. The web cartridge refurbishment verification logic 600 includes logic for verifying the refurbishment of the installed web cartridge 50. This can be accomplished by checking the spit web 38 and the wipe web 40 with the wipe web encoder 81, the drive motor 84 and the sensor 60 respectively.

The web cartridge refurbishment verification logic 620 includes verification parameters related to the spit web 38 and the wipe web 40. Accordingly, through a series of tests, the web cartridge refurbishment verification logic 620 can verify that the web cartridge has been properly refurbished.

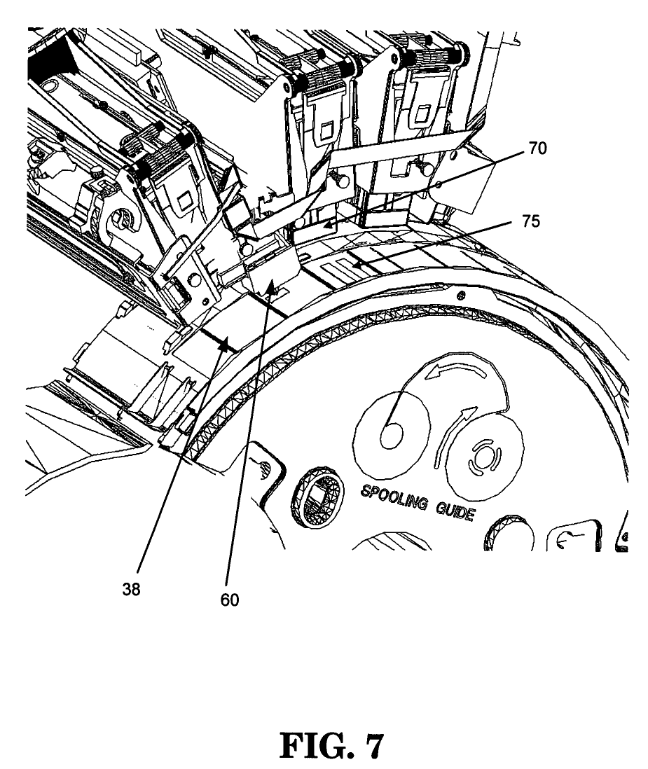

To understand how the refurbishment of the spit web 38 is verified, please refer now to FIG. 7. FIG. 7 shows the sensor 60 and a black pen 70. Accordingly, the sensor 60 reads a saturation value from a clean section of the spit web 38. Saturation values are values associated with the amount of ink saturation on the web, e.g. a high saturation value is associated with a dark color whereas a low saturation value is associated with light/no color. A small amount of black ink is then discharged from the black pen 70 onto the spit web 38. The spit web 38 is then advanced in small increments, within a small range, while the sensor 60 reads the saturation values. A transition of the saturation value readings from white to dark back to white indicates that the spit web 38 is properly installed and moving accurately.

To verify the refurbishment of the wipe web 40, the web drive motor 84 is activated and the wipe web 40 is advanced. As the wipe web 40 advances, the wipe web encoder wheel 82 is read in order to verify the advancement of the wipe web encoder 81. Accordingly, once the advancement of the wipe web encoder 81 is verified, the internal encoder 83 of the web drive motor 84 is read in order to verify the web drive motor 84 is advancing the web fabric. Consequently, once the advancement of the wipe web encoder 81 and the internal encoder 83 of the web drive motor 84 are verified, the refurbishment of the wipe web 40 is verified. Once the refurbishment of both webs 38, 40 are verified, the printing apparatus 10 operates normally. If either detection fails, the apparatus 10 indicates which verification failed so that the associated problem can be addressed.

A method of verifying web cartridge refurbishment is disclosed. The method includes installing a refurbished web cartridge in a print apparatus, the print apparatus including an encoder and a web sensor and utilizing the encoder and the web sensor to verify refurbishment of the installed web cartridge. By implementing this method, a quick and reliable refurbishment of the web cartridge is completed in a more cost effective and efficient manner.

The above-described embodiment may also be implemented, for example, by operating a computer system to execute a sequence of computer readable instructions. Accordingly, a computing device typically includes at least some form of computer readable media. Computer readable media can be any available media that can be accessed by computing device. By way of example, and not limitation, computer readable media may include computer storage media and communications media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage device, or any other medium which can be used to store the desired information and which can be accessed by a computing device.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media. Accordingly, an alternate embodiment includes a computer readable medium having computer executable components for verifying web cartridge refurbishment.

Without further analysis, the foregoing so fully reveals the gist of the present inventive concepts that others can, by applying current knowledge, readily adapt it for various applications without omitting features that, from the standpoint of prior art, fairly constitute essential characteristics of the generic or specific aspects of this invention. Therefore, such applications should and are intended to be comprehended within the meaning and range of equivalents of the following claims. Although this invention has been described in terms of certain embodiments, other embodiments that are apparent to those of ordinary skill in the art are also within the scope of this invention, as defined in the claims that follow.

1. A method of verifying web cartridge refurbishment comprising:
installing a refurbished web cartridge in a print apparatus, the print apparatus comprising an encoder and a web sensor; and
utilizing the encoder and the web sensor to verify refurbishment of the installed web cartridge.

2. The method of claim 1 wherein the web sensor further comprises an optical sensor.

3. The method of claim 2 wherein utilizing the encoder and the optical sensor further comprises:
reading a saturation value with the optical sensor.

4. The method of claim 1 wherein the encoder further comprises a wipe web encoder, the web cartridge further comprises a wipe web, the print apparatus further comprises a drive motor, and utilizing the encoder and the web sensor further comprises:
reading the wipe web encoder to verify an advancement of the wipe web via the drive motor.

5. The method of claim 3 wherein a transition of the saturation value from white to dark back to white indicates proper web cartridge refurbishment.

6. A printing apparatus comprising:
a wipe web encoder;
a web sensor; and
means for utilizing the wipe web encoder and the web sensor to verify a refurbishment of an installed web cartridge.

7. The apparatus of claim 6 wherein the web sensor further comprises an optical sensor.

8. The apparatus of claim 7 wherein the means for utilizing the encoder and the optical sensor further comprises:
means for reading a saturation value with the optical sensor.

9. The apparatus of claim 6 further comprising a drive motor and utilizing the wipe web encoder and the web sensor further comprises:
means for reading the wipe web encoder to verify an advancement of the wipe web via the drive motor.

10. The apparatus of claim 8 wherein a transition of the saturation value from white to dark back to white indicates proper web cartridge refurbishment.

11. The apparatus of claim 6 wherein the means for utilizing the wipe web encoder and the web sensor further comprises a refurbishment verification module.

12. The apparatus of claim 11 wherein the refurbishment verification module further comprises web cartridge refurbishment verification logic for verifying the refurbishment of the installed web cartridge.

13. A computer program product for verifying web cartridge refurbishment in a print apparatus, the computer program product comprising a computer usable medium having computer readable program means for causing a computer to perform the steps of:
utilizing an encoder and a web sensor to verify refurbishment of an installed web cartridge.

14. The computer program product of claim 13 wherein the web sensor further comprises an optical sensor.

15. The computer program product of claim 14 wherein utilizing the encoder and the optical sensor further comprises:
reading a saturation value with the optical sensor.

16. The computer program product of claim 13 wherein the encoder further comprises a wipe web encoder, the web cartridge further comprises a wipe web, the print apparatus further comprises a drive motor, and utilizing the encoder and the web sensor further comprises:
reading the wipe web encoder to verify an advancement of the wipe web via the drive motor.

17. The computer program product of claim 15 wherein a transition of the saturation value from white to dark back to white indicates proper web cartridge refurbishment.
